(19) United States
(12) Patent Application Publication
(10) Pub. No.: US 2006/0206816 A1
(43) Pub. Date: Sep. 14, 2006

(54) Method of and device for predictive text editing

(76) Inventor: Magnus Nordenhake, Malmo (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/078,758

(22) Filed: Mar. 11, 2005

(51) Int. Cl. G06F 17/24

(52) U.S. Cl. 715/534

(57) ABSTRACT

A method of editing text data within a text-data string includes the steps of a) receiving a key stroke. The key stroke is received via one of a plurality of keys and at least one of the plurality of keys corresponds to a character group includes a plurality of characters. The method also includes b) displaying a character selected from the character group in accordance with a predictive-editor program, c) creating a text-data string responsive to pressing of the plurality of keys in a desired sequence, d) displaying characters corresponding to the entered text-data string, e) positioning a cursor adjacent to an incorrect character identified by a user, f) displaying a menu, and g) receiving a selection of one of the plurality of characters for insertion in place of the incorrect character. The menu includes a plurality of characters. This Abstract is provided to comply with rules requiring an Abstract that allows a searcher or other reader to quickly ascertain subject matter of the technical disclosure. This Abstract is submitted with the understanding that it will not be used to interpret or limit the scope or meaning of the claims. 37 CFR 1.72(b).

### BACKGROUND OF THE INVENTION

1. Technical Field

The present invention relates generally to electronic devices having a predictive-editor application for entering and editing data, and more particularly, but not by way of limitation, to a communication terminal, such as a cellular phone or cordless phone, where the editor application is used for editing text data using a minimal number of key strokes.

2. History of Related Art

Tegic Communications, Inc. (“Tegic”) is one of a number of companies that deliver software that allows users to enter text data into an electronic device using key strokes. A predictive-editor program developed by Tegic, T9®, attempts to automatically determine an intended word from all possible matches of words present in a linguistic database associated with the program. In addition, users of the T9® predictive-editor program are able to customize the database by adding their own words. However, before a new word can be added to the database, a user must first create the customized word. The process of creating a customized word requires switching from the T9® mode to what, is known as multi-tap mode. The multi-tap mode allows a user to enter text data by tapping a key multiple times, where the key is associated with a plurality of letters, symbols or numbers.

Typically, a user might attempt to use the T9® mode to enter text data only to find that the intended word was not present in the database. Text data is defined herein as data used to represent characters such as, for example, letters, numbers, or symbols. A text-data string represents a plurality of characters arranged in a particular sequence. A character string is a displayed plurality of characters arranged in a particular sequence. For purposes of this application, a word may be any pre-defined character string and the term ‘spelling’ refers to conformance of a character string to a particular desired sequence of characters.

Upon being presented with an incorrect word, the user would come to realize that the intended word was not present in the linguistic database. In such a case, the user often must enter a menu, choose to spell the word, and then change to a new mode that enables the user to edit the word via multi-tap mode input(s), erase the incorrectly spelled letters, and then spell the word using multiple key strokes in the multi-tap mode. All of these actions often result in the user having to use numerous key strokes in order to arrive at a particular word. Additionally, the user would expend twice as much time to arrive at the correct spelling of a word by virtue of attempting to spell it first with the T9® program, only to have to erase the incorrect letters in order to correctly spell the word using the text editor in the multi-tap mode.

### SUMMARY OF THE INVENTION

A method of editing text data within a text-data string includes the steps of a) receiving a key stroke. The key stroke is received via one of a plurality of keys and at least one of the plurality of keys corresponds to a character group includes a plurality of characters. The method also includes b) displaying a character selected from the character group in accordance with a predictive-editor program, c) creating a text-data string responsive to pressing of the plurality of keys in a desired sequence, d) displaying characters corresponding to the entered text-data string, e) positioning a cursor adjacent to an incorrect character identified by a user, f) displaying a menu, and g) receiving a selection of one of the plurality of characters for insertion in place of the incorrect character. The menu includes a plurality of characters.

The steps d) through g) may be repeated in order until the desired characters are displayed. The method may be implemented in a mobile terminal and the predictive-editor program may be T9. Step g) may include scrolling through the plurality of characters in the menu of step f) and receiving a selection of the desired character. The plurality of characters may correspond to a plurality of characters associated with the same key as the incorrect character.

An electronic device includes a keypad for receiving text data. The keypad includes a plurality of keys. At least one of the plurality of keys corresponds to a character group includes a plurality of characters. The electronic device also includes a display for displaying characters associated with the text data and a predictive-editor program capable of providing candidate character sequences that correspond to a key-press sequence of the plurality of keys. The predictive-editor program is capable of providing a plurality of selectable characters for insertion into a displayed character string to replace an incorrect character of the displayed character string.

The electronic device may include a mechanism for selecting a replacement character for the incorrect character. The mechanism for selecting a replacement character may be a joystick. The device may be a cellular telephone. The plurality of selectable characters may correspond to a plurality of characters associated with the same key as the incorrect character.

An article of manufacture for editing text data in a text-data string, the article of manufacture includes at least one computer-readable medium and processor instructions contained on the at least one computer-readable medium, the processor instructions configured to be readable from the at least one computer readable medium by at least one processor and thereby cause the at least one processor to operate as to a) receive a key stroke. The key stroke is received via one of a plurality of keys and each of the plurality of keys corresponds to a character group includes a plurality of characters. The processor instructions are configured to cause the at least one processor to also operate as to b) responsive to receipt of the key stroke, display a character selected from the character group in accordance with a predictive-editor program, c) create a text-data string responsive to receipt of a plurality of key strokes in a desired sequence, d) display a character string corresponding to the entered text-data string, e) responsive to user input, position a cursor adjacent to an incorrect character, f) display a menu, wherein the menu includes a plurality of characters, and g) receive a selection of one of the plurality of characters from the menu for insertion in place of the incorrect character.

The processor instructions may further cause the at least one processor to repeat steps d) through g) in order until a desired sequence of characters is displayed. The processor instructions may cause the at least one processor to operate in a mobile terminal using the T9 predictive-editor program. The processor instructions may further cause the at least one processor to scroll through the plurality of characters and select the desired character responsive to user input. The plurality of characters may correspond to a plurality of characters associated with the same key as the incorrect character.

### BRIEF DESCRIPTION OF THE DRAWINGS

A more complete understanding of the present invention may be obtained by reference to the following Detailed Description of Illustrative Embodiments of the Invention, when taken in conjunction with the accompanying Drawings, wherein:

FIG. 1 illustrates a mobile communication terminal according to an embodiment of the invention;

FIG. 2 is a block diagram of the mobile communication terminal of FIG. 1;

FIG. 3 illustrates the major components of the predictive editor according to an embodiment of the invention;

FIG. 4 illustrates a display sequence when entering text data in accordance with an embodiment of the invention; and

FIG. 5 is a flow diagram for handling that illustrates the method of text editing using a predictive-text editor in a communication terminal according to an embodiment of the invention.

### DETAILED DESCRIPTION OF ILLUSTRATIVE EMBODIMENTS OF THE INVENTION

Embodiment(s) of the invention will now be described more fully with reference to the accompanying drawings. The invention may, however, be embodied in many different forms and should not be construed as limited to the embodiment(s) set forth herein. The invention should only be considered limited by the claims as they now exist and the equivalents thereof.

Certain terminology is used herein for convenience only and is not to be construed as a limitation of any aspect of the invention. For example, words such as “upper”, “lower”, “left”, “right”, “horizontal”, “vertical”, “upward” and “downward” are used herein to describe the configuration shown in the drawings. Indeed, the various components described as part of the drawings may be oriented in any direction and the terminology, and should therefore be understood as encompassing such variations. Although the terms ‘letters’ and ‘spelling’ are used in this Detailed Description for ease of description of aspects of various embodiments of the invention, it will be appreciated by those having skill in the art that the invention is not limited to characters that are letters and that the term ‘spelling’ refers to conformance of a character string to a particular desired sequence of characters and not merely to conformance of a sequence of letters to a particular sequence defined by, for example, the English language.

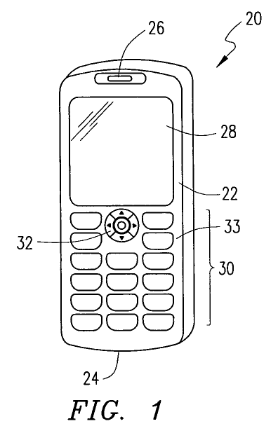

The invention relates to the use of a predictive-text editor for entering text data. Referring now to the Drawings, wherein like reference numerals designate corresponding or similar elements throughout the several views, a mobile terminal is shown and generally designated at 20. The mobile terminal 20 is adapted for communication in a wireless communication network. In the embodiment shown in FIG. 1, the mobile terminal 20 is a cellular telephone.

Referring now to FIG. 1, the mobile terminal 20 includes a case or housing 22, which may be of any desired size and shape. The housing 22 includes a mouthpiece 24 for inputting sound, an earpiece 26 for receiving sound, a display 28, and keypad 30 with standard alphanumeric keys such as are found on many conventional mobile terminals. Various other controls may also be provided on the mobile terminal, some of which may be used with features according to the claimed invention as described below. Examples of these features include a joy stick 32, which can be used to adjust the point of insertion of text data, and a “Clear” button 33, which can be used to delete text entries. The cellular telephone represented in FIG. 1 generally resembles Sony Ericsson Model No. T637.

Although the mobile terminal 20 is illustrated in FIG. I in the form of a cellular telephone, it should be understood that the mobile terminal 20 need not be so limited and may find utility in other applications including, but not limited to, a Personal Communications System (PCS) terminal that may combine a cellular telephone with data processing, facsimile and data communication capabilities; a Personal Digital Assistant (PDA); and a conventional laptop or other computer system that includes a receiver for generating different levels of sound.

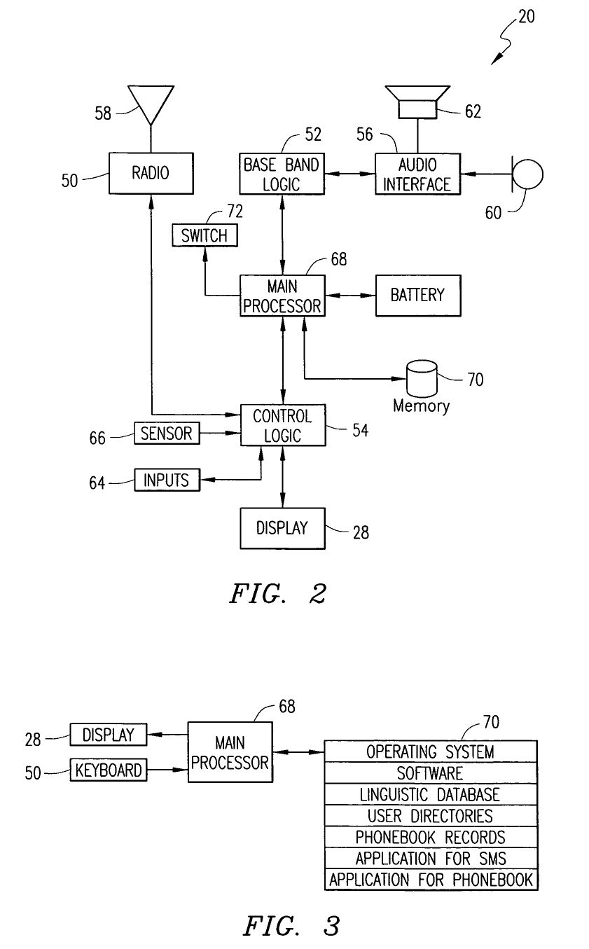

Referring now to FIG. 2, a block diagram of the mobile terminal 20 is shown. The mobile terminal 20 includes a radio block 50, a baseband logic block 52, a control logic block 54, an audio interface block 56. Within the radio block 50, receive and transmit information is converted from and to the radio frequencies (RF) of various carrier types, and filtering using baseband or intermediate frequency circuitry is applied, as understood in the art. Connected to the radio block 50 is an antenna system 58 for sending and receiving radio signals between the mobile terminal 20 and a wireless communication network. In the baseband logic block 52, basic signal processing occurs, e.g., synchronization, channel coding, decoding and burst formatting, as is understood in the art.

The audio interface block 56 handles voice as well as analog-to-digital (A/D) and D/A processing. The audio interface block 56 also receives input through a microphone 60 and produces output through a speaker 62. The speaker 62 can be any of a number of electroacoustic transducer types.

The control logic block 54 controls and coordinates the functions of the aforementioned blocks and also plays an important role in controlling human interface components such as a display 28 and inputs 64. The control logic block 54 may include processing circuitry such as general-purpose microprocessors, digital signal processors (DSPs), application specific integrated circuits (ASICs), various types of signal conditioning circuitry, including analog-to-digital converters, digital-to-analog converters, input/output buffers, etc., such as a main processor 68, which is shown for illustrative purposes only.

In various embodiments, steps may be carried out by elements of the main processor 68 executing sequences of instructions. The instructions may be stored in a memory 70 as program code, often in the form of microcode, and data that enables the operation of the mobile terminal 20 through the processor or processors so that the mobile terminal can operate within the wireless communication network. The memory 70 may include one or more physical memory devices, which may include volatile storage devices, non-volatile storage devices, or both. For example, the memory 70 may include both random access memory (RAM), read-only memory (ROM), various forms of programmable and/or erasable (ROM) (e.g., PROM, EPOM, EEPROM, etc.), flash memory, or any combination of such devices. Software instructions or data may be loaded into the mobile terminal 20 from another device, such as a remote computer system, over a wireless connection.

To facilitate the description, it is henceforth assumed that various tasks are generally carried out through the execution of software instructions in the mobile terminal 20. It is envisioned that these instructions may be written, for example, in the JAVA language, or alternatively in C or C++. Note, however, that other languages may be substituted within the scope of the present invention. As is well-known, JAVA is a programming application designed specifically for network-connectable applications on consumer devices. The details of developing software in JAVA is well-known to those skilled in the relevant art and are not required for an understanding of the principles of the present invention. Accordingly, such details are not provided herein.

Various embodiments of the present invention may be implemented by hard-wired circuitry rather than by executing software, or by a combination of hard-wired circuitry with software. Hence, it will be recognized that the present invention is not limited to any specific combination of hardware circuitry and software, nor to any particular source for software instructions.

FIG. 3 illustrates components of a predictive-text editor in accordance with principles of the invention. The display 28 and the keyboard 30 each interact with the main processor 68, which executes instructions and reads data from and writes data to the memory 70. The memory 70 includes instructions for an operating system, linguistic databases, vocabularies, and optionally one or more application programs, such as, for example, an SMS message handling application. Target application programs for the predictive-text editor used in a handset may include, but are not necessarily limited to, an electronic phone book, notepad, messages, calendar and Internet browsing. The mobile terminal 20 may use a predictive-editor program, for example T9®, as well as a multi-tap text editing program. In a predictive text-editing mode, a user can enter text data by finding words that match a string of entered characters stored in a linguistic database. Therefore, in the predictive text-editing mode, the user presses a particular key only once regardless of which of the alphanumeric symbols (represented by the particular key) the user desires. Conversely, in the multi-tap editing mode, the user presses the relevant key as many times as required to obtain the particular symbol sought by the user. For example if a user wishes to enter the letter “c” in the multi-tap editing mode, the user must press the key “2/abc” a total of three times.

Table 1 shows a key layout of the keyboard 30. When starting to type a word, the user presses the alphanumeric key containing the desired letter once.

TABLE 1

| | | |
|---|---|---|
| 1 | 2/abc | 3/def |
| 4/ghi | 5/jkl | 6/mno |
| 7/pqrs | 8/tuv | 9/wxyz |

Using various known methods, if, for example, the user wants to type the word “dachshund”, the user presses each of the following keys once in sequence: “3/def” to insert the “d”, “2/abc” to insert the “a'“2/abc” to insert the “c'“4/ghi” to insert the “h”, “7/pqrs” to insert the “s”, “4/ghi” to insert the “h”, “8/tuv” to insert the “u”, “6/mno” to insert the “n” and “3/def” to insert the “d”. When the desired word “dachshund” is not present in the linguistic database of the predictive-editor program, the result of the single key input may be, for example, “eachritof”.

The user can switch to the multi-tap editing mode and perform the following steps to arrive at the desired word “dachshund.” The user can press the “Clear” button 33 five times to delete the letters “f”, “o”, “t”, “i” and “r” (from right to left). The edited word now reads “each”. The joystick 32 may be used to move the cursor (which is typically present on the right side of the last entered text data or symbol) to a position on the right side of the letter “e” in the edited word “each.” The user can press the “Clear” button 33 one time to delete the letter “e”. The key “3/def” may be pressed to insert the letter “d” to arrive at the word “dach.” The joystick 32 may be used to move the cursor to the right side of the letter “h” of the edited word “dach”. The “7/pqrs” key may be pressed four times to enter the letter “s”, the “4/ghi” key may be pressed two times to enter the letter “h”, the “8/tuv” key may be pressed two times to enter the letter “u”, the “6/mno” key may be pressed two times to enter the letter “n” and the “3/def” key may be pressed one time to enter the letter “d”. The resulting word is “dachshund” which is the word desired by the user. However, the total number of key strokes necessary to convert the incorrect word “eachritof” to the correct word “dachshund”, as described above, is at least seventeen. When the number of moves by the joystick 32 is included, a total of twenty-three actions is required by a user to correct “eachritof” to “dachshund” using the multi-tap editing mode.

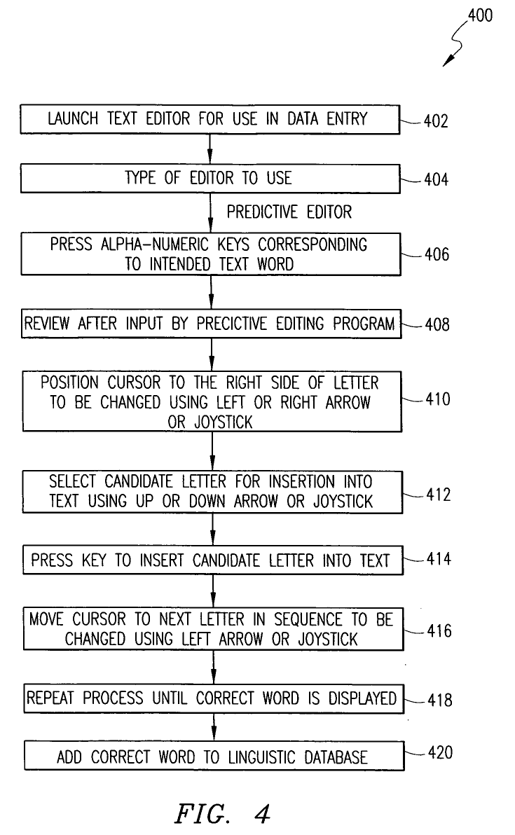

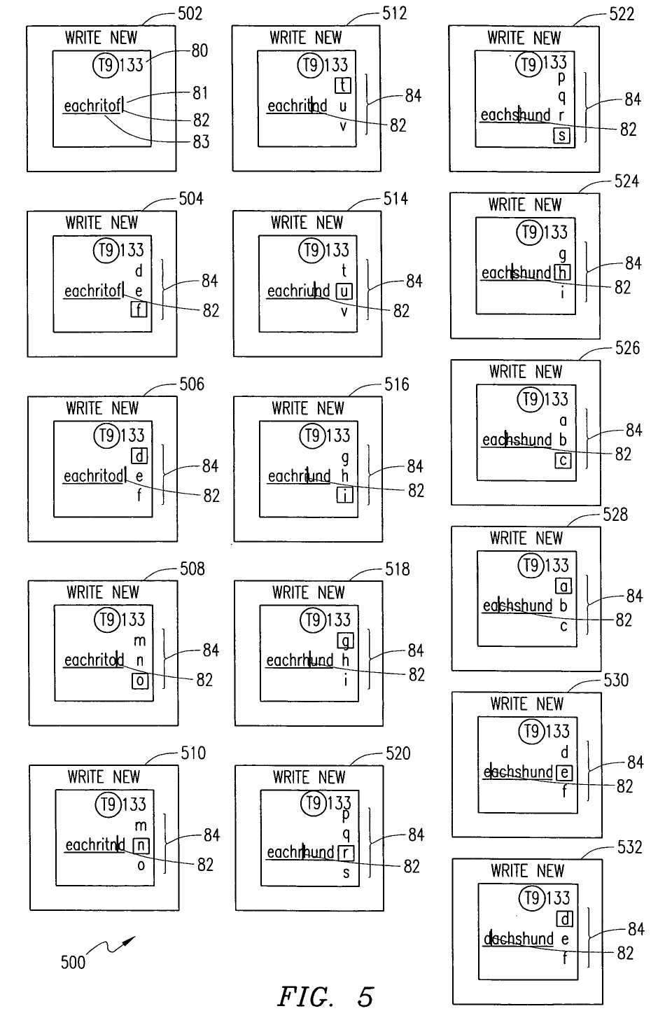

Various embodiments of the invention allow a user to perform the correction of the word “eachritof” to “dachshund” with fewer key strokes as described below. FIG. 4 is a flow diagram illustrating a step-wise process by which a user corrects a word using a text editing program. The flow diagram 400 begins at step 402, where the user launches a text editor for use in text entry. From step 402, execution proceeds to step 404. In step 404, the user determines the type of editor to use. In the particular example illustrated in FIG. 4, the user chooses a predictive editor in step 404. From step 404, execution proceeds to step 406. In step 406, the user presses the alphanumeric keys in a specific sequence to enter the intended text data. From step 406, execution proceeds to step 408. In step 408, the user reviews the display and determines that the intended word is incorrectly spelled because it is not present in the linguistic database of the predictive-editor program. From step 408, execution proceeds to step 410. In step 410, the user begins editing the word by positioning the cursor (see 82 in FIG. 5 below), to the right side of the letter to be corrected. From step 410, execution proceeds to step 412. In step 412, the user selects the candidate letter to be inserted from a vertical menu (see 84 in FIG. 5 below). From step 412, execution proceeds to step 414. In step 414, the user inserts the candidate letter into the text being edited. From step 414, execution proceeds to step 416. In step 416, the user moves the cursor (see 82 in FIG. 5 below) to the right side of the next letter to be changed in the character string. From step 416, execution proceeds to step(s) 418. In step(s) 418, the above-described process as set forth in steps 410-416 is repeated until the correct word is displayed. After the correct word is displayed, it is added to the linguistic database as shown in step 420.

Referring now to FIG. 5, a series of text entry displays 500 illustratively describe the text editing process set forth in the flow diagram of FIG. 4. The first display 502 shows that the user has entered the word eachritof 81. The word is underlined 83 which indicates that the user is operating on the word. A cursor 82 indicates the end of the current word and the position where the next text data will be entered. In the example of FIG. 5, the user intended to enter the word “dachshund”, but the predictive text editor came up with the word “eachritof.” The displays 505 to 532 have an icon row 80, which shows that the predictive editor, T9®, is enabled, and a counter that illustrates the further number of characters, 133, that may be entered into the character string.

In the case of the incorrect word “eachritof”, the user determines which of the letters needs to be changed in order to arrive at the correct word “dachshund”. Responsive to the user choosing to spell the word, while remaining in the edit-message mode, the user moves the joy stick to position the cursor 82 to the right side of the last letter “f” as shown in display 504. Upon positioning of the cursor 82, a vertical menu 84 appears to the right of the menu with a listing of possible candidate letters. The vertical menu 84 typically lists the characters present on the same key as the incorrect letter. As seen in display 504, when the cursor 82 is present to the right side of the letter “f”, the vertical menu 84 displays the letters “d”, “e” and “f”. The user selects the letter “d” for insertion in place of the incorrect letter “f” as shown in display 506.

Following the insertion of the correct letter “d”, the user moves the cursor in the appropriate direction to the next letter that needs to be changed and follows the same procedure discussed above. As shown in display 508, when the cursor 82 is positioned to the right of the letter “o”, the vertical menu 82 displays the letters “m”, “n” and “o”. The user selects the letter “n” for insertion in place of the incorrect letter “o” as shown in display 510. As indicated in displays 512 to 532, the described process is repeated until the correct word “dachshund” is displayed.

Referring back to FIG. 5, the cursor 82 is moved in a leftward direction using the joy stick, until it is to the right side of the letter “o”. The vertical menu 64 displays the letters “m”, “n” and “o”. The user inserts the letter “n” into the word. As shown in FIG. 5, the process can be repeated until the correct word “dachshund” is displayed. Using this method, the total number of actions employed by the user is sixteen, which is fewer that the number of actions required using other methods.

It should be emphasized that the terms “comprise”, “comprises”, and “comprising”, when used herein, are taken to specify the presence of stated features, integers, steps, or components, but do not preclude the presence or addition of one or more other features, integers, steps, components or groups thereof. The previous Detailed Description is of embodiment(s) of the invention. The scope of the invention should not necessarily be limited by this Description.

What is claimed is:

1. A method of editing text data within a text-data string, the method comprising the steps of:
a) receiving a key stroke, wherein said key stroke is received via one of a plurality of keys and at least one of said plurality of keys corresponds to a character group comprising a plurality of characters;
b) displaying a character selected from said character group in accordance with a predictive-editor program;
c) creating a text-data string responsive to pressing of the plurality of keys in a desired sequence;
d) displaying characters corresponding to the entered text-data string;
e) positioning a cursor adjacent to an incorrect character identified by a user;
f) displaying a menu, wherein said menu comprises a plurality of characters; and
g) receiving a selection of one of the plurality of characters for insertion in place of the incorrect character.

2. The method of claim 1, wherein steps d) through g) are repeated in order until the desired characters are displayed.

3. The method of claim 1, wherein the method is implemented in a mobile terminal and the predictive-editor program is T9.

4. The method of claim 1, wherein step g) comprises scrolling through the plurality of characters in the menu of step f) and receiving a selection of the desired character.

5. The method of claim 4, wherein the plurality of characters correspond to a plurality of characters associated with the same key as the incorrect character.

6. An electronic device comprising:
a keypad for receiving text data;
wherein the keypad comprises a plurality of keys;
wherein at least one of said plurality of keys corresponds to a character group comprising a plurality of characters;
a display for displaying characters associated with the text data; and
a predictive-editor program capable of providing candidate character sequences that correspond to a key-press sequence of the plurality of keys;
wherein the predictive-editor program is capable of providing a plurality of selectable characters for insertion into a displayed character string to replace an incorrect character of the displayed character string.

7. The electronic device of claim 6, further comprising a mechanism for selecting a replacement character for the incorrect character.

8. The electronic device of claim 7, wherein the mechanism for selecting a replacement character is a joystick.

9. The electronic device of claim 6, wherein the device is a cellular telephone.

10. The electronic device of claim 6, wherein the plurality of selectable characters corresponds to a plurality of characters associated with the same key as the incorrect character.

11. An article of manufacture for editing text data in a text-data string, the article of manufacture comprising:
at least one computer-readable medium;
processor instructions contained on the at least one computer-readable medium, the processor instructions configured to be readable from the at least one computer readable medium by at least one processor and thereby cause the at least one processor to operate as to:
a) receive a key stroke, wherein said key stroke is received via one of a plurality of keys and each of said plurality of keys corresponds to a character group comprising a plurality of characters;
b) responsive to receipt of the key stroke, display a character selected from said character group in accordance with a predictive-editor program;
c) create a text-data string responsive to receipt of a plurality of key strokes in a desired sequence;
d) display a character string corresponding to the entered text-data string;
e) responsive to user input, position a cursor adjacent to an incorrect character;
f) display a menu, wherein said menu comprises a plurality of characters; and
g) receive a selection of one of the plurality of characters from the menu for insertion in place of the incorrect character.

12. The article of claim 11, wherein the processor instructions further cause the at least one processor to repeat steps d) through g) in order until a desired sequence of characters is displayed.

13. The article of claim 11, wherein the processor instructions cause the at least one processor to operate in a mobile terminal using the T9 predictive-editor program.

14. The article of claim 11, wherein the processor instructions further cause the at least one processor to scroll through the plurality of characters and select the desired character responsive to user input.

15. The article of claim 11, wherein the plurality of characters corresponds to a plurality of characters associated with the same key as the incorrect character.
